(19) United States
(12) Patent Application Publication
(10) Pub. No.: US 2004/0079397 A1
(43) Pub. Date: Apr. 29, 2004

(54) Process and apparatus for pickling a metal piece after welding

(76) Inventors: Pentti Aspinen, Jyv?auml;skyl?auml; (FI); Tapani Koikkalainen, Lievestuore (FI); Jaakko Reivo, Jyv?auml;skyl?auml; (FI); Raimo Räsänen, Jyv?auml;skyl?auml; (FI)

Correspondence Address: Christopher J Fildes, Fildes & Outland, Suite 2, 20916 Mack Avenue, Grosse Pointe Woods, MI, 48236, US

(21) Appl. No.: 10/471,106

(22) PCT Filed: Mar. 11, 2002
(86) PCT No.: PCT/FI02/00190

(30) Foreign Application Priority Data
Mar. 9, 2001 (FI) 20010469

(51) Int. Cl. B08B 7/04; B08B 3/00

(52) U.S. Cl. 134/41; 134/3; 134/10; 134/104.2; 134/186; 134/56 R

(57) ABSTRACT

A process and a moveable container for pickling a metal piece after welding is disclosed in which process the metal piece is brought into contact with an acid surface-treatment agent in the area of the welded joint and the heat-affected zone, the surface treatment agent is allowed to act on the area for a set period of time, the surface treatment agent is removed from the surface of the metal piece with the aid of a neutralizing wash fluid, the wash fluid is chemically treated with an alkalizing agent and an agent that increases the floc size, the chemically treated wash fluid is taken for clarification to form a clarified liquid and a sediment, the heavy-metal waste accumulated during clarification is taken to a hazardous waste treatment plant.

The present invention relates to a process and apparatus for pickling a metal piece after welding, in which

the metal piece is brought into contact with an acid surface-treatment agent in the area of the welded joint and the heat-affected zone,

the surface treatment agent is allowed to act on the said area for a set period of time,

the surface treatment agent is removed from the surface of the metal piece with the aid of a neutralizing wash fluid,

the wash fluid is collected and taken to be cleaned,

the wash fluid is chemically treated with an alkalizing agent and an agent that increases the floc size,

the chemically treated wash fluid is taken to be clarified to form a clarified liquid and a sediment,

the heavy-metal waste accumulated during clarification is taken to hazardous waste treatment.

The passivated surface of stainless chrome steel becomes oxidized, for example, when a metal piece is welded, hot levelled, or similarly heat-treated. The oxidized and chrome-poor zones or areas have been put into an active state during the treatment and have lost the corrosion-resistant properties of the base material. Additional faults created in a metal piece during welding often also include filler residues, slag, and impurities. As the oxidized areas have lost their desired corrosion-resistant properties, it is extremely important to remove the oxide layer.

The oxide layer can be removed either mechanically or chemically. When mechanical removal is used, for example, by wire-brushing a welded joint, hereinafter generally referred to as a weld, it is necessary not only to remove visible blemishes, but also to ensure that the weld area is passivated. The best result is achieved using a chemical surface treatment, which hereinafter will be generally referred to as pickling. In pickling, chemicals suitable for the purpose penetrate the oxide layer and the metal beneath it, dissolving the chrome-poor zone and oxidizing a passive film onto the surface of the metal piece.

The pickling chemicals used at present are based, for example, on hydrogen fluoride (HF, fluorhydric acid), or a mixed acid of fluorhydric and nitric acid (HNO₃). Nitric acid forms strong nitrogen oxides (NOₓ), which contaminate the air for breathing, which has led to the development of reason pickling chemicals in which nitric acid has been replaced with hydrogen peroxide. Chemicals are also available, in which hydrogen fluoride has been replaced with sulphuric, hydrochloric, or phosphoric acid. No matter what chemicals are used, significant handling, hazardous waste, and work hygiene problems relate to pickling.

The most popular pickling method is tank pickling, in which the metal piece to be pickled is totally immersed in a fixed tank of pickling chemicals in the workshop hall. Besides this, local brush pickling, using a paste or gel, is used. When carried out correctly, both give excellent results in terms of the corrosion resistance of the metal piece. Generally the neutralization and washing of the pickling agent from the surface of the metal piece is carried out on the floor of the workshop hall, using a neutralizing wash fluid, which is collected and drained into an intermediate store, to await further processing. When using local brush pickling, absorption cloths are used to wipe the pickling agent off the surface of the metal piece. Both the wash fluid and the absorption cloths contain heavy metals dissolved from the weld by the pickling agent, such as chromium (Cr), nickel (Ni), molybdenum (Mo), and iron (Fe), as well the fluorides and nitrogen oxides contained in the pickling agent, which are, along with the aforesaid heavy metals, hazardous waste. The treatment of hazardous wastes is now governed by strict environmental regulations, which require the wash waters and cleaning implements used, such as the absorption cloths, to be collected and sent for treatment to a hazardous waste treatment plant.

Finnish patent FI 45867 (=CA 775321) discloses a method for pickling using sulphuric acid, in which, after pickling, the piece is flushed with an alkali solution, which is circulated in the process by adding an alkali at the sedimentation stage, to compensate for the addition of acid from the piece. This publication does not, however, deal with the problem caused by heavy metals while the process is difficult to apply, as such, as a moveable unit.

Nowadays, pickling is carried out as much as possible under workshop conditions. However, depending on the installation location of the metal pieces, it often happens that it is. impossible to predict the positioning, in the actual location site, of the pieces being installed. This can happen, for example, on a paper-machine rebuild site, where pipework must be welded on site in suitable positions on the machine, thus creating as many as hundreds or even thousands of welds, each one of which must be pickled, to prevent corrosion. In addition to the pipe components, there are also others, such as all kinds of small pieces and field welds in general, with a width of usually 30-50 mm. Under present legislation, heavy metal emissions require environmental permits irrespective of the actual heavy-metal content. Due, for example, to paper mills' modern water-treatment processes, which are based on biological methods, and to the closed-circulation of the process waters of paper machines, these processes are extremely sensitive,- for example, to heavy metals and to compounds with widely varying degrees of acidity. In addition, it is difficult for paper mills to obtain environmental permits for pickling, as their drainage and waste water treatment systems do not meet the environmental regulations governing pickling. This completely eliminates field pickling that takes place at the installation site, during which substances used in pickling may enter the mill's waste water drains. Field pickling treatment is also a question of work safety, because during pickling operations persons not involved in the work should be present. Because, according to the present technology, all welds are pickled on site, field pickling reduces production by increasing downtime.

The present invention is intended to create a new type of process and apparatus, which are suitable for use in a moveable unit while nevertheless meeting strict environmental requirements. By means of the process according to the invention, both pickling and the treatment of pickling wastes take place at the installation site, in the manner required by environmental statute, in such a way that the liquids to be drained are cleaned to be suitable for disposal in a drain and the heavy metals dissolved in the liquids are separated to be sent, for example, to a hazardous waste treatment plant. With the aid of the apparatus according to the invention, which is preferably arranged in a closed and watertight intermodal transport container, it is possible to pickle all welds, except for welds between pieces of different metals, which must still be field pickled out at the installation site.

The characteristic features of the process according to the invention are stated in claim 1 and the characteristic features of the apparatus in claim 4. In the process according to the invention, clarification takes place intermittently, so that the partially clarified liquid is led several times to be reused as a wash fluid for the removal and neutralization of the surface-treatment agent, while final clarification is carried out only after several reuses of the wash fluid. The apparatus according to the invention is fitted inside a moveable intermodal transport container, in which there is a watertight isolated pickling/washing area for carrying out the surface treatment and washing, and devices for processing the wash fluid. The moveable container imposes no load on the environment. The bottom of the pickling/washing area has a wash tank and collector drain to collect the wash fluid in a chemicalization tank during washing, which tank also has dosing devices for the sedimentation of the collected wash fluid. The container also has a sedimentation tank for separating the clarified liquid and the sediment and an intermediate storage tank for the partly clarified fluid, as well as means for leading the wash fluid from the collector drain to the chemicalization tank and then to the sedimentation tank, and for leading the clarified liquid to the intermediate storage tank and then to the wash room. In addition, the container has means for drying the sediment and removing it from the circulation.

The heavy-metal sediment created in connection with the cleaning of the wash fluid can be transported for treatment, for example, either to a hazardous waste treatment plant or an electrolysis plant. The closed wash fluid circulation allows a significant reduction in the amount of chemicals required.

According to a second preferred embodiment, the apparatus is also fitted with an ion-exchange system, by means of which the heavy-metal contents of the fluids can be further reduced and the clarified liquid obtained from the cleaning can be drained according to even very strict values.

The invention permits pickling at field sites while taking environmental legislation into account. A customer ordering pickling treatment no longer has to take care of the necessary environmental permits, because the moveable container containing the apparatus meets the environmental standards for the treatment of pickling waste with a heavy-metal content. Similarly, the fluid circulations of the customer's own cleaning and production processes are not endangered during pickling, as this preferably takes place in a container that is closed and isolated from the customer's processes. Using the wash fluid treatment apparatus located in the container, the wash fluid is cleaned in a reasonable time to a degree of cleanness in which it can be advantageously reused as an alkali to neutralize the acid pickling agent and to remove it from the surface of the pickled metal piece. The devices and absorption cloths used in pickling can also be processed in the apparatus. The container is easy to move from place to place and rapidly prepare for operation.

In the following, the invention is described with reference to the accompanying drawings, which depict the process and apparatus according to the invention, in which

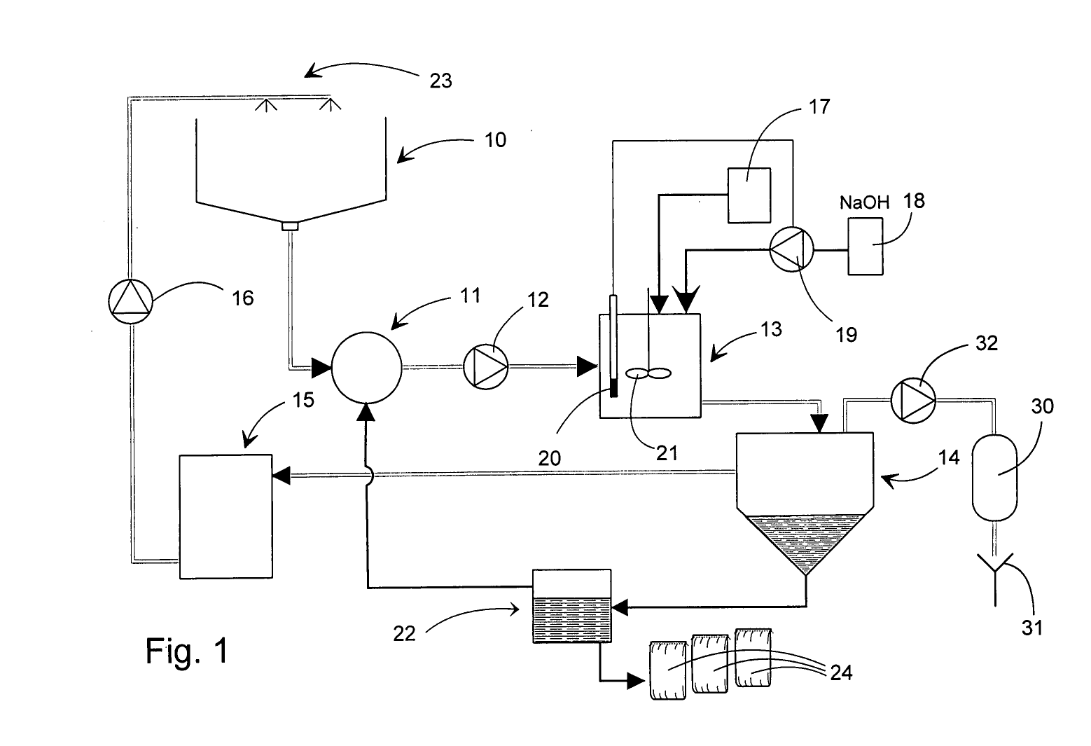

FIG. 1 shows a schematic diagram of the wash fluid treatment process according to the invention,

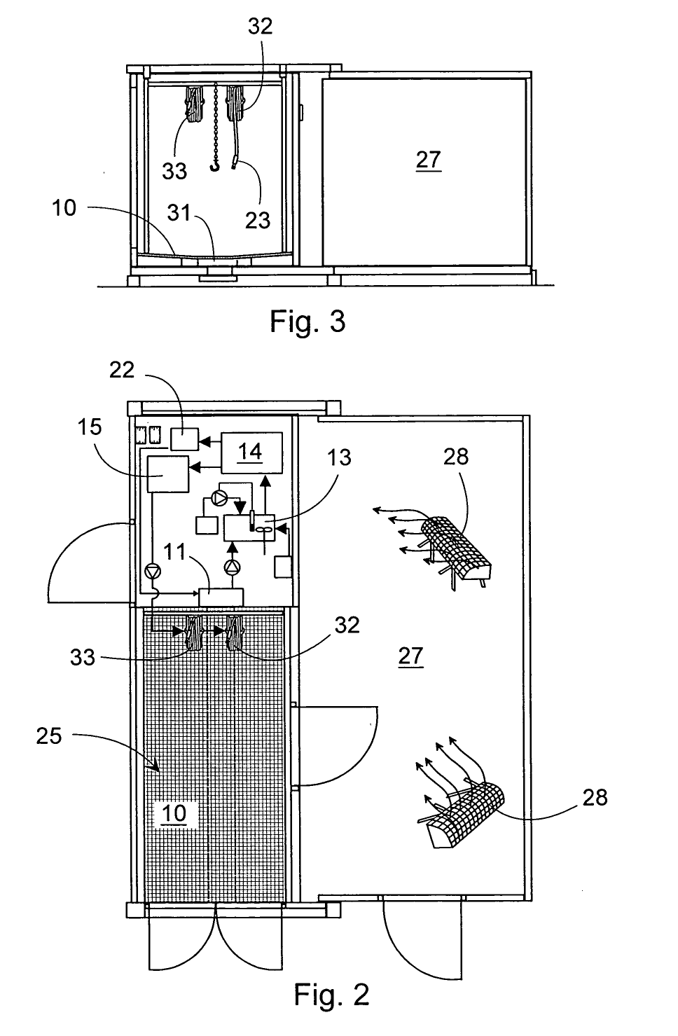

FIG. 2 shows a layout drawing of the pickling container according to the invention,

FIG. 3 shows a cross-section of the container according to the invention,

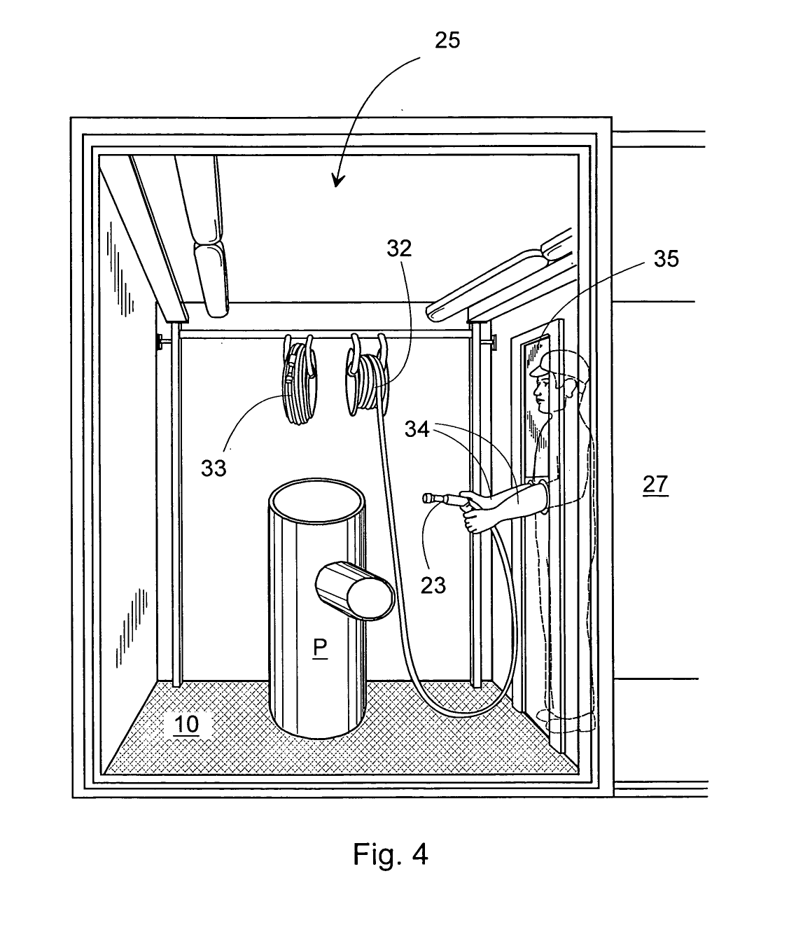

FIG. 4 shows the container's protective equipment for the washing stage.

FIG. 1 shows a diagram of the wash fluid treatment process according to the invention. The actual pickling is carried out as brush pickling, which simplifies the process when compared to immersion pickling. The stated volumes are suitable for batch pickling a metal piece and are given as examples. The collector drain 11, into which the acid (pH 1,5-3,5) pickling agent and the alkali (pH 9,5-10) wash fluid are led from the wash tank 10, has a capacity of 0,5 m³. From the collector drain 11, the solution is lifted by means of a pump 12 to a chemicalization tank 13, in which a mixer device 21 and a pH sensor 20 are arranged. In the process according to the example, the chemicalization tank 13 has a capacity of 0,5 m³. The pH value in the chemicalization tank 13 is maintained within the range 9,5-10 by adding sodium hydroxide (NaOH) from a tank 18 with a capacity of 30 1.

The process according to the invention is based on chemical precipitation, in which an alkali precipitation chemical, for example, sodium hydroxide, is added to a solution with a metal content, when the free metal ions in the solution are precipitated. Thus, it is possible to speak of so-called hydroxide-precipitation. To promote the combination and precipitation of the particles during the chemicalization stage, a precipitating additive, for example, a polyelectrolyte in powder form dissolved in water, with a content of preferably 0,1%, is also added to the tank 13 from a tank 17. In the process, the polyelectrolyte acts to increase the size of the floc of the heavy metals, thus promoting their settling.

After chemicalization, the liquid is transferred to a clarification tank 14, the bottom of which is preferably conical, and the capacity of which in the process according to the example is 1,0-1,5 m³. Here the liquid is held, for example, for about 10 minutes, during which time the sediment, which has been created by means of hydroxide precipitation and increased in size by means of the polyelectrolyte solution, mostly settles to the bottom of the clarification tank 14. Flotation (not shown) is another possible means of separation. During the settling time of 10 minutes, the sediment achieves a solids content of 0,1-0,5%, when the heavy-metal content of the partially clarified liquid will have decreased to such an extent (1-3 mg), that no practical benefit is gained from a longer settling time, in terms of washing and cleaning effect. From the clarification tank 14, the sediment can be transferred, for example, either to mechanical drying 22, such as a mechanical chamber press, or to bag drying, particularly to a SICC© sand-bed-bag dryer (WO94/29230). The heavy-metal sediment, with a solids content of about 30%, is bagged in sacks 24 and sent to hazardous waste treatment. The liquid (reject) that has dripped out during drying 22 is led to the collector drain 11, from which it continues to circulate along the route described above. The partially clarified liquid obtained from the clarification tank 14 is led on to an intermediate storage tank 15 (1 m³) and pumped by the pump 16 for reuse in the next washing.

The process (at least the clarification) according to the above description is intermittent in such a way that clarification is normally not allowed to finish (1-2 days), instead the partly clarified liquid (10 min.) is led to the intermediate storage tank 15 for reuse as a neutralizing wash fluid. Only after several circulations is the wash fluid completely clarified and entirely removed from the process. The operation is then restarted with clean water. The contents of the heavy metals (Fe, Cr, Ni) in the completely clarified liquid are each about 0,2 mg/l. Alternatively a proportion corresponding to the fresh water addition is removed daily.

FIG. 2 shows the layout plan of a pickling container for implementing the method and apparatus according to the invention, while FIG. 3 shows a cross-section of the container. According to a preferred embodiment, container is 20-feet long, allowing it to be transported to the point of application using conventional transportation equipment. The container has a conventional basic construction and is equipped with trucklifting tunnels and container corners, but in it the modular technology of Oy Morehouse Ltd, known under the ‘Big More’ trademark, is applied. One side of the container opens out to form an auxiliary space, creating a total operating floor area, including the extension, of 30 m². The container is divided into three rooms, of which the actual container section has a combined pickling/washing room 25 and a wash water treatment room 26, the extension section on one side of the container having an auxiliary and drying area 27, in which heaters 28 are located, to improve the drying of the metal pieces after pickling.

The pickling/washing room 25 is isolated to be watertight and a lifting device 29 is arranged in it to move the metal pieces and to support them on top of the wash tank 10. The lifting device 29 is, for example, a block and tackle and preferably can be moved along and across above the wash tank 10 by means of rails arranged in the ceiling of the container. Two washing hose reels 32, 33, with spray pistols 23 on the washing hoses to manually wash off the pickling agent, are also arranged in the washing/pickling room 25. Partial clarified liquid from the wash fluid in the intermediate storage tank 15 is pumped, using the pump 16 in the wash fluid treatment room 26, to the spray pistols 23. In addition, a spray washer, which can be used to wash larger metal pieces, can also be arranged in the ceiling of the container. The second hose reel 33 can be reserved for clean water. The bottom of the wash tank 10 is preferably made with a slight fall from the sides of it to the centre and a further fall to the collector drain 11, to which the fluid is led by a gutter 31.

The piece to be pickled, in which all the possible welds have been made, except for the final welds joining the pieces together, is brought to the container and lifted into the wash tank 10, using the hoist 29. The welds to be pickled are brushed at the selected points with an acid pickling agent, which is, for example, a gel-like substance containing hydrogen fluoride (HF) and nitric acid (HNO₃), and which has a pH value of 1,5-3,5. In terms of work health, a less desirable method is to spread the pickling agent by a spray (not shown), in which case the agent is in a liquid form. The pickling agent is allowed to act for a set period of time, after which it is washed off using neutralizing water, containing, for example, NaOH. Washing takes place by spraying wash fluid onto the surface of the pickled metal piece using, for example, a spray nozzle moved pneumatically in the ceiling of the pickling/washing room. The metal piece is finally washed with a small quantity of clean raw water. For this purpose, the apparatus includes a small raw water tank and/or a clean water connection (not shown).

During passivation, the temperature in the container is maintained at +35° C. Warm-air blowing can be used to accelerate considerably the process of the development of the passive film while simultaneously drying the metal piece more rapidly and allowing it to be brought to its installation location without dripping liquid. According to one preferred embodiment, circulating air (not shown), which extracts humidity from the container, is also arranged in the container. The pilot-stage research demonstrated that raising the temperature by only 20 degrees will shorten the drying time to half of its original duration.

According to one preferred embodiment, the process includes -an ion-exchange system in the external drainage, to which the wash fluid is led, after being allowed to settle overnight in the settling tank 14. Ion exchange is a chemical reaction, in which an ion in a solution is exchanged for a similarly charged ion of ion-exchange resin. The ion-exchange system gives a further reduction in the heavy-metal content of the liquid clarified in the settling tank 14. According to the embodiment of FIG. 1, the clarified liquid from the settling tank 14 is led, with the aid of its own pump 32, to a disposable composite exchanger column 30, containing both cationic and anionic resins. By allowing the clarified liquid to stand for a set period of time in this column, the cationic resins exchange the hydrogen ions in the clarified liquid for positively-charged ions and correspondingly the anionic resin exchanges the hydroxyl ions for negatively-charged, for example, molybdenum ions. The special resins used in the ion exchanger have a very great affinity for specific metal ions, including heavy-metal ions.

These resins retain only heavy-metal ions, even though the solution may contain larger concentrations of normal ions. The reactions can be predicted and the capacity of the resin calculated. Once the maximum capacity of the resin has been reached, the resins are not revived in the process according to the invention, instead the resins in the exchanger are replaced. Once the liquid has been run through the ion-exchanger, it can be led either to the drain 31, or taken to a hazardous waste treatment plant, for example, for the removal of fluorides, depending on the local environmental legislation. In one test, the heavy-metal contents of the liquid taken to the drain were quite low after ion-exchange cleaning:

Fe 0,15 mg/l

Cr 0.010 mg/l

Ni 0,078 mg/l

Mo 0,013 mg/l.

The operating life of a disposable composite exchanger can be as long as several years, making it highly suitable for use in a moveable pickling container.

If necessary, the apparatus in the example described can be used round the clock without a break for a period of about two weeks, without being connected to an external drain. After that, the properties of the wash fluid change to such an extent that it no longer has the required washing properties.

The wash water can be reused as wash water in the process, as after the cleaning process it is alkali and is eminently suitable for neutralizing the pickling acid in the process. In Finland, the wash water can be led to a drain after only settling, as its heavy-metal contents remain under the proposed limit values for waste water led to a public drain (0,5 mg/l for Ni and Cr, no proposed limit values for Fe and Mb, pH value 6-11) though the molybdenum content is rather high. After settling for as little as ten minutes, the cleaned water can be reused as wash water.

In order to improve work-health conditions, the container preferably includes the protective equipment shown in FIG. 4. The piece P is washed from outside the washing room, in this case from the auxiliary area 27. Protective gloves 34 are inserted into the door opening between the washing room 25 and the auxiliary area 27 and a window 35 is used for protection while carrying out the washing. Thus, the operator is entirely protected from the mist rising from the washing, which contains noxious substances.

1. A process for pickling a metal piece after welding, in which
the metal piece is brought into contact with an acid surface-treatment agent in the area of the welded joint and the heat-affected zone,
the surface treatment agent is allowed to act on the said area for a set period of time,
the surface treatment agent is removed from the surface of the metal piece with the aid of a neutralizing wash fluid,
the wash fluid is collected and taken to be cleaned,
the wash fluid is chemically treated with an alkalizing agent and an agent that increases the floc size,
the chemically treated wash fluid is taken for clarification to form a clarified liquid and a sediment, and in which
clarification is carried out intermittently, in such a way that the clarified liquid is led to be reused several times as the wash fluid to remove and neutralize the surface treatment agent, characterized in that
in addition to the alkalizing agent used in sedimentation, a polyelectrolyte is used to include the floc size and to bind the heavy metal particles, and
the heavy-metal waste accumulated during clarification is taken to a hazardous waste treatment plant, and
the clarification is terminated only after several reuses of the wash fluid.

2. A process according to claim 1, characterized in that the pH value in the sedimentation is regulated to between 9 and 10,5.

3. A process according to claim 1 or 2, characterized in that the sediment containing heavy metals is dried in a manner that it, as such, known using a sand-bed-bag dryer to remove it from the process and the reject liquid formed during drying is returned to the chemicalization.

4. A moveable apparatus for pickling a metal piece, in which apparatus are arranged at least means for treating the piece with a surface-treatment agent, means for removing the surface-treatment agent using a neutralizing wash fluid, and means for collecting and cleaning the wash fluid and recycling it for reuse, characterized in that the apparatus is fitted in a moveable intermodal transport container, in which there is a watertight pickling/washing room (25) for carrying out the surface-treatment of the piece as brush pickling and for washing the piece, as well as process means (13-16) for cleaning the wash fluid.

5. An apparatus according to claim 4, characterized in that the container includes
a pickling/washing room (25) with a wash tank (10) and a collector drain (11) arranged on the bottom of it for collecting the wash fluid in connection with the washing,
a chemicalization tank (13) and chemical dosing devices for carrying out the sedimentation of the collected wash fluid,
a clarification tank (14) for separating the clarified liquid and the sediment from the sedimented wash fluid,
an intermediate storage tank (15) for the partly clarified fluid,
means (12, 16) for leading the wash fluid from the collector drain (11) to the chemicalization tank (13) and then to the clarification tank (14), and for leading the clarified liquid to the intermediate storage tank (15) and then to the washing room (25), and means (22) for drying the sediment and removing it from the circulation.

6. An apparatus according to claim 5, characterized in that means (20) for measuring the pH value, with the aid of which the chemical dosing means (19) are arranged to be regulated, are arranged in at least one tank (13, 14, 15).

7. An apparatus according to claim 5 or 6, characterized in that the apparatus includes ion-exchange units arranged for the final treatment of the clarified liquid, which units comprise a disposable composite ion-exchanger (30), in which there are cationic and anionic exchange resins in the same vessel.

8. An apparatus according to any of claims 4-7, characterized in that the container includes a pull-out drying/auxiliary space (27).

9. An apparatus according to any of claims 4-8, characterized in that the container includes a wash-water treatment room (26), in which the aforesaid means for the cleaning process are located, and which is separated from the other room.

10. An apparatus according to any of claims 4-9, characterized in that the apparatus includes an raw water tank and/or a clean water connection.

11. An apparatus according to any of claims 4-10, characterized in that the apparatus includes protective gloves (34) and a window (35) for use from outside the washing room (25), preferably from the drying/auxiliary space (27), for protecting the operator carrying out the washing.
